(19) United States
(12) Patent Application Publication
(10) Pub. No.: US 2012/0054730 A1
(43) Pub. Date: Mar. 1, 2012

(54) IMAGE PROCESSING APPARATUS CAPABLE OF REDUCING TIME REQUIRED TO UPDATE SOFTWARE, METHOD OF CONTROLLING THE SAME, INFORMATION PROCESSING SYSTEM, AND STORAGE MEDIUM

(75) Inventor: Takumi MICHISHITA, Kawasaki-shi (JP)

(73) Assignee: CANON KABUSHIKI KAISHA, Tokyo (JP)

(21) Appl. No.: 13/217,427

(22) Filed: Aug. 25, 2011

(30) Foreign Application Priority Data
Aug. 27, 2010 (JP) 2010-190722

(51) Int. Cl. G06F 9/44

(52) U.S. Cl. 717/169

(57) ABSTRACT

An image processing apparatus that localizes portions of software to be updated before performing software difference updating, to thereby make it possible to reduce time required for the update. The image processing apparatus receives update files from an update server on a network, and updates software based on the update files. The software is stored in a software storage area in a flash memory in a state divided into compressed files. The compressed files to be updated are decompressed out of the stored compressed files. The decompressed files are updated based on the update files received from the update server. The updated files are recompressed and stored in the software storage area.

### BACKGROUND OF THE INVENTION

1. Field of the Invention

The present invention relates to an image processing apparatus and a method of controlling the same, and an information processing system, and more particularly to a technique for updating software installed in a digital multifunction peripheral or the like.

2. Description of the Related Art

In recent years, in an image processing apparatus such as a digital multifunction peripheral, the update of installed software (including firmware) can be performed by a user himself/herself. When updating software, software for the update is generally downloaded from a server on a network or from an external storage medium. However, this sometimes increases time to transfer the software for the update.

To optimize the time to transfer the software for the update, various kinds of difference updating methods are being studied. For example, there has been disclosed an updating method in which in storing a plurality of modules in a memory, empty areas are secured between the modules, and update data is stored in the empty areas (Japanese Patent Laid-Open Publication No. 2000-293366). This makes it possible to update the modules by minimum data transfer.

Further, to reduce an area for storing programs in a memory, there has been disclosed a method in which programs are stored in the memory as a compressed file, whereby the data area for storing programs is largely reduced (Japanese Patent Laid-Open Publication No. 2009-009392).

However, in the software difference updating, it is necessary to perform processing for decompressing downloaded update data into a file. When a compression file system is used, in general, it is necessary, in the update of software, to decompress all of compressed files and recompress differences after the update, and hence it takes a long time to decompress and recompress the files. Therefore, this causes a problem of increasing time required to update the software.

In Japanese Patent Laid-Open Publication No. 2000-293366, although it is possible to update software using differences, a ROM image of the differences in its original form is downloaded, which increases the amount of data transferred from the server. Further, portions to be updated are not identified in advance.

In Japanese Patent Laid-Open Publication No. 2009-009392, although programs are arranged in the form of compressed code, it is necessary to decompress all of the compressed code in updating software, which increases processing time required for the whole update of the software.

### SUMMARY OF THE INVENTION

The present invention provides a technique that localizes portions of software to be updated before performing software difference updating, to thereby make it possible to reduce time required for the update.

In a first aspect of the present invention, there is provided an image processing apparatus that receives at least one update file from a server on a network, and updates software based on the at least one update file, comprising a storage unit configured to store the software in a state divided into a plurality of compressed files, a decompression unit configured to decompress at least one compressed file to be updated out of the plurality of compressed files stored in the storage unit, an update unit configured to update the at least one compressed file decompressed by the decompression unit, based on the at least one update file received from the server, and a compression unit configured to recompress and store the at least one compressed file which is decompressed and updated, in the storage unit.

In a second aspect of the present invention, there is provided a method of controlling an image processing apparatus that receives at least one update file from a server on a network, and updates software based on the at least one update file, comprising storing the software in a state divided into a plurality of compressed files, decompressing at least one compressed file to be updated out of the plurality of compressed files stored in the storage unit, updating the decompressed at least one file, based on the at least one update file received from the server, and recompressing and storing the at least one compressed file which is decompressed and updated, in the storage unit.

In a third aspect of the present invention, there is provided an information processing system including an image processing apparatus that receives at least one update file from a server on a network, and updates software based on the at least one update file, the image processing apparatus comprising a storage unit configured to store the software in a state divided into a plurality of compressed files, a decompression unit configured to decompress at least one compressed file to be updated out of the plurality of compressed files stored in the storage unit, an update unit configured to update the at least one compressed file decompressed by the decompression unit, based on the at least one update file received from the server, and a compression unit configured to recompress and store the at least one compressed file which is decompressed and updated, in the storage unit, the server comprising a software construction information reception unit configured to receive software construction information including names and versions of respective packages forming the software from the image processing apparatus, a difference software-determining unit configured to determine at least one difference package by comparing the received software construction information with update software information for identifying differences from updated software, a compressed file identification unit configured to identify the at least one compressed file to be updated from difference package information on the at least one difference package determined by the difference software-determining unit, an update time calculation unit configured to calculate a processing time period required to update the software from the difference package information and information on the at least one identified compressed file, and an update information transmission unit configured to transmit update information including the difference package information and the update processing time period to the image processing apparatus, wherein the decompression unit identifies and decompresses the at least one compressed file to be updated based on the update information received from the server.

In a fourth aspect of the present invention, there is provided an information processing system including an image processing apparatus that receives at least one update file from a server on a network, and updates software based on the at least one update file, the image processing apparatus comprising a storage unit configured to store the software in a state divided into a plurality of compressed files, a decompression unit configured to decompress at least one compressed file to be updated out of the plurality of compressed files stored in the storage unit, an update unit configured to update the at least one compressed file decompressed by the decompression unit, based on the at least one update file received from the server, a compression unit configured to recompress and store the at least one compressed file which is decompressed and updated, in the storage unit, an update software construction information reception unit configured to receive update software information for identifying differences from updated software, from the server, a difference software-determining unit configured to determine at least one difference package by comparing software construction information including names and versions of respective packages forming the software with the received update software information, a compressed file identification unit configured to identify the at least one compressed file to be updated from difference package information on the at least one difference package determined by the difference software-determining unit, and an update time calculation unit configured to calculate a processing time required to update the software from the difference package information and information on the identified at least one compressed file, wherein the decompression unit identifies and decompresses the at least one compressed file to be updated based on update information including the difference package information and the update processing time period.

In a fifth aspect of the present invention, there is provided a non-transitory computer-readable storage medium storing a computer-executable program for causing a computer of an image processing apparatus to execute a method of controlling the image processing apparatus that receives at least one update file from a server on a network, and updates software based on the at least one update file, wherein the method comprises storing the software in a state divided into a plurality of compressed files, decompressing at least one compressed file to be updated out of the plurality of compressed files stored in the storage unit, updating the decompressed at least one file, based on the at least one update file received from the server, and recompressing and storing the at least one compressed file which are decompressed and updated, in the storage unit.

According to the present invention, before it is possible to localize portions of software to be updated before performing software difference updating, to thereby make it possible to reduce time required for the update.

Further features of the present invention will become apparent from the following description of exemplary embodiments with reference to the attached drawings.

### BRIEF DESCRIPTION OF THE DRAWINGS

FIG. 1 is a simplified block diagram of an image processing apparatus according to a first embodiment of the present invention.

FIG. 2 is a detailed block diagram of the image processing apparatus shown in FIG. 1.

FIG. 3 is a schematic block diagram of modules of the image processing apparatus according to the first embodiment for performing update processing therein and modules of an update server for update processing.

FIG. 4 illustrates a flow of conventional software difference updating.

FIG. 5 illustrates a flow of software difference updating performed in the first embodiment.

FIG. 6A illustrates an example of software construction information and updating software information for identifying differences of the software.

FIG. 6B illustrates an example of difference package information indicative of contents of the difference packages

FIG. 7 is a sequence diagram showing a flow of a software update process performed between the image processing apparatus according to the first embodiment and the update server.

FIGS. 8A and 8B are a flowchart of a part of the software update process shown in FIG. 7, which is executed by the image processing apparatus.

FIG. 9 is a flowchart of a part of the software update process shown in FIG. 7, which is executed by the update server.

FIG. 10 is a schematic block diagram of modules of a image processing apparatus according to a second embodiment for performing update processing therein and modules of an update server for performing update processing.

FIG. 11 is a sequence diagram showing a flow of a software update process performed between the image processing apparatus according to the second embodiment and the update server.

### DESCRIPTION OF THE EMBODIMENTS

The present invention will now be described in detail below with reference to the accompanying drawings showing embodiments thereof. Note that in figures, portions having the same function are denoted by the same reference numeral, and redundant description thereof is omitted.

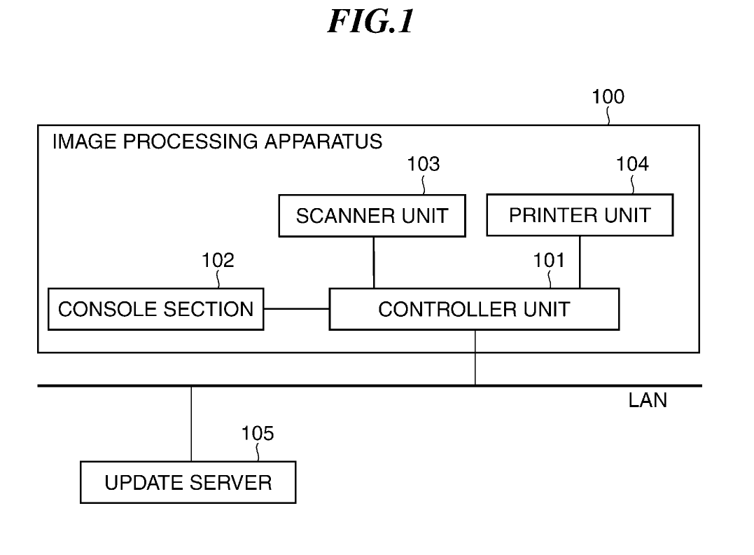

FIG. 1 is a simplified block diagram of an image processing apparatus according to a first embodiment of the present invention.

An image processing apparatus 100 is a multifunction peripheral (MFP) that performs inputting and outputting images, transmitting and receiving images, and various kinds of image processing. The image processing apparatus 100 comprises a scanner unit 103 as an image input device, a printer unit 104 as an image output device, a controller unit 101, and a console section 102 as a user interface.

The scanner unit 103, the printer unit 104, and the console section 102 are connected to the controller unit 101, respectively, and are controlled by commands from the controller unit 101. Further, the controller unit 101 is connected to a LAN (local area network) outside the image processing apparatus 100, and is capable of communicating with an update server 105 via the LAN.

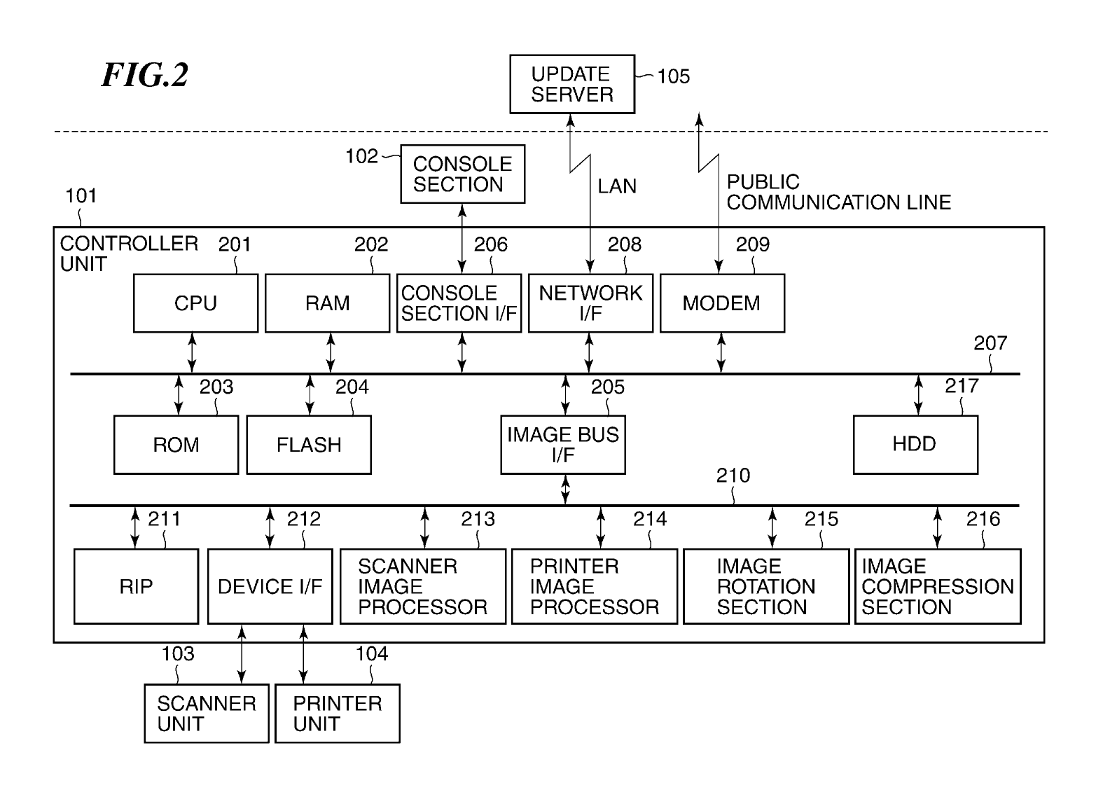

Next, a description will be given of the configuration of the image processing apparatus 100 with reference to FIG. 2.

FIG. 2 is a detailed block diagram of the image processing apparatus 100 shown in FIG. 1.

As shown in FIG. 2, the image processing apparatus 100 includes the controller unit 101 for controlling the overall operation of the apparatus. The controller unit 101 controls the scanner unit 103 and the printer unit 104, and is connected to the LAN and a public communication line to input and output image information, device information, files, etc. from and to an external apparatus via the LAN or the public communication line.

The controller unit 101 has a CPU 201. The CPU 201 is connected to a RAM 202, a ROM 203, a flash memory 204, an image bus interface 205, a console section interface 206, a network interface 208, and a modem 209 via a system bus 207.

The RAM 202 is a memory for providing a work area for the CPU 201. The RAM 202 is also used as an image memory for temporarily storing image data. The ROM 203 is a boot ROM, and stores a boot program for the system. The flash memory 204 stores system software (firmware), settings data, and so forth.

The console section interface 206 provides interface with the console section 102, for inputting and outputting information from and to the console section 102. The console section interface 206 outputs to the console section 102 image data to be displayed on thereon. The console section interface 206 also plays the role e.g. of transferring information input by the user via the console section 102 to the CPU 201.

The network interface 208 is connected to the LAN for inputting and outputting information from and to the LAN. The modem 209 is connected to the public communication line for inputting and outputting information from and to the public communication line. The image bus interface 205 is a bus bridge that connects between the system bus 207 and an image bus 210 for high-speed transmission of image data, and at the same time converts the data structure of the image data.

A RIP (raster image processor) 211, a device interface 212, a scanner image processor 213, a printer image processor 214, an image rotation section 215 and an image compression section 216 are connected to the image bus 210.

The RIP 211 rasterizes a PDL (page description language) code received via the LAN into a bitmap image. The device interface 212 connects the scanner unit 103 and the printer unit 104 to the controller unit 101, and performs synchronous-to-asynchronous or asynchronous-to-synchronous conversion of image data. The scanner image processor 213 performs correction, processing, editing and so forth of input image data. The printer image processor 214 performs correction, resolution conversion, etc. on image data to be printed out. The image rotation section 215 rotates image data. The image compression section 216 carries out expansion and compression processing on multivalued image data by JPEG, and binary image data e.g. by JBIG, MMR or MH.

A HDD 217 is a storage device which can be mounted and removed by the user, for storing image data, address book data, and a job log, and further data (preference data) personally recorded by the user, such as favorites recording frequently used settings and computer shortcuts. Note that when the HDD 217 is not connected, the above-mentioned various kinds of data items are stored in the flash memory 204.

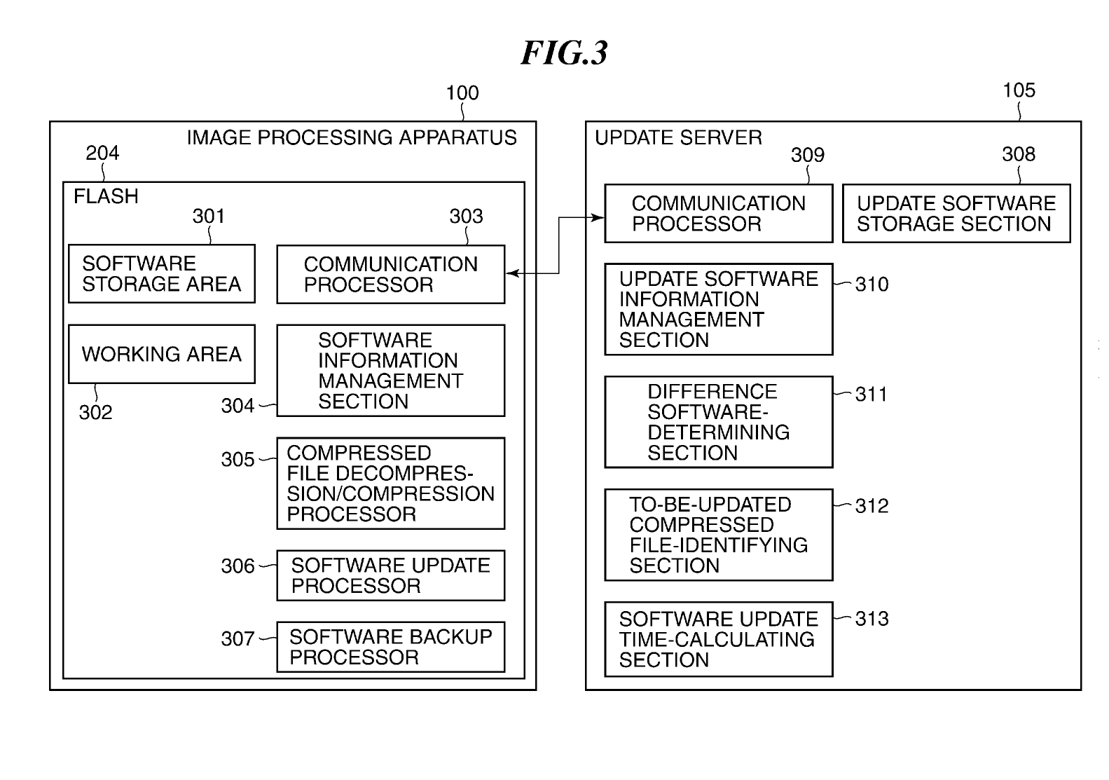

FIG. 3 is a schematic block diagram of modules of the image processing apparatus for performing update processing therein and modules of the update server 105 for update processing.

The update processing within the image processing apparatus is executed by the controller unit 101 and the modules, described hereinafter. These modules are stored in the flash memory 204 as shown in FIG. 3, and provide functions, described hereinafter, according to instructions and commands from the controller unit 101.

In FIG. 3, a software storage area 301 is an area which stores a system program for realizing the operations of the image processing apparatus 100. Software to be updated is a program stored in this area. A working area 302 is an area for temporarily storing print data and image files in the normal operation, and in the update operation, operations, such as those of a job, are stopped, and using this area, compressed files of the program are decompressed, and update files are applied thereto.

Communication processors 303 and 309 are modules for inputting and outputting update software, software construction information, etc. between the image processing apparatus 100 and the update server 105. Note that these modules may be implemented by hardware.

In the image processing apparatus 100, a software information management section 304 is a management module for managing software construction information, such as version information on the system program stored in the software storage area 301 and construction information on a compressed file. A compressed file decompression/compression processor 305 is a module for decompressing and recompressing software compressed and stored in the software storage area 301.

A software update processor 306 is a module which performs processing for decompressing update software received from the update server 105, and applying updated files to a program decompressed by the compressed file decompression/compression processor 305.

A software backup processor 307 is a module which backs up a compressed file to be updated before decompressing software by the compressed file decompression/compression processor 305, for recovery processing in a case where an error occurs during the update of software.

In the update server 105, an update software storage section 308 is a storage area (or a storage device) for collectively storing data of a plurality of pieces of software managed by the update server 105. An update software information management section 310 is a management module which holds the software construction information, such as version information on the system program for update processing, stored in the update software storage area 308, and construction information on a compressed file. A difference software-determining section 311 is a module which compares the software construction information received from the image processing apparatus 100 with the construction information on software to be updated to thereby determine difference software.

A to-be-updated compressed file-identifying section 312 is a module which identifies a compressed file to be updated based on the difference software information determined by the difference software-determining section 311. A software update time-calculating section 313 calculates a processing time required for the software update by taking into account difference software information and information on a compressed file to be updated, and device information on the image processing apparatus to be updated. An update processing time period is determined by taking into account a time period for transfer of all update files, a time period for decompression of compressed file, a time period for decompressing update files, a time period for applying update files, and a time period for recompressing updated decompressed files. Note that the above-described function modules within the update server 105 may be implemented by hardware.

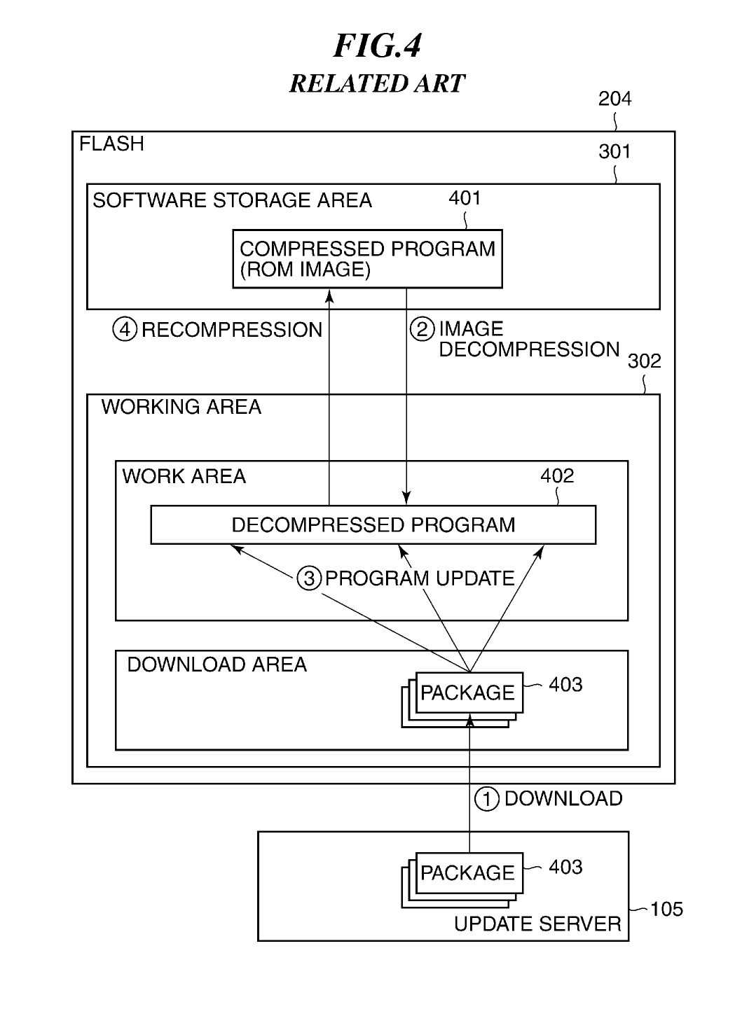

FIG. 4 illustrates a flow of the conventional software difference updating.

The system program is stored in the software storage area 301 as one compressed program (ROM image) 401. In the update of software, the compressed program 401 is all decompressed in a work area within the working area 302 in advance. The program in this state is referred to as a decompressed program 402. Then, a difference package group 403 is downloaded from the update server 105 into a download area within the working area 302. The downloaded difference package group 403 is decompressed and is applied to the decompressed program 402. Note that the unit of download contains one or a plurality of program files, and the unit of download is referred to as the “package”. Finally, the updated program is recompressed into the compressed program 401, and is stored in the software storage area 301. This procedure not only takes a long time to decompress and recompress the program but also requires a large capacity of the work area.

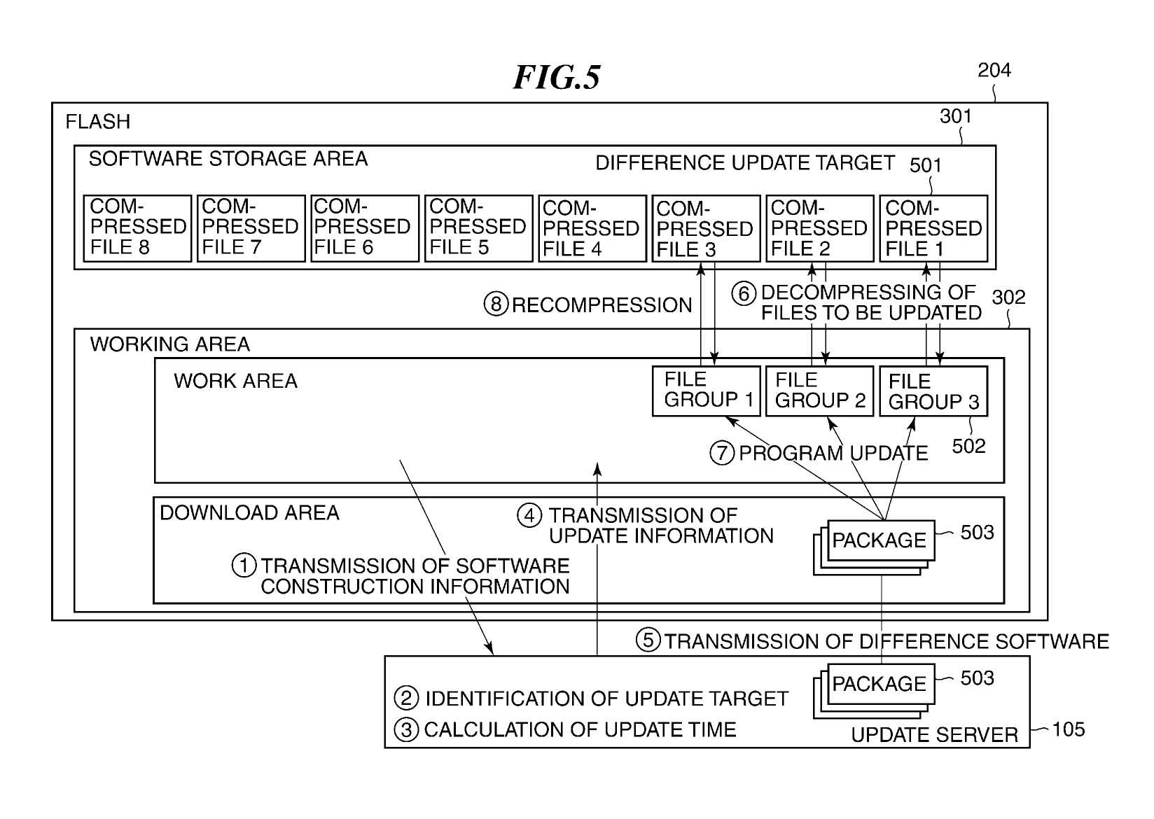

FIG. 5 illustrates a flow of the software difference updating in the first embodiment.

In the present embodiment, the system program is divided into a plurality of compressed files 501 having no interdependency, and the compressed files 501 are stored in the software storage area 301. At this time, to maintain the performance of the image processing apparatus 100 (hereinafter also simply referred to as the “device”), it is necessary to set the number of compressed files to a range of approximately 10 to 20. Note that in the illustrated example, the system program is divided into eight compressed files.

A difference package group 503 is downloaded into the download area within the working area 302 from the update server 105 on the network. To minimize a download amount in the difference update, it is preferable to divide the difference package group 503 into a larger number of files than the number of the compressed files, and reduce each size.

Before the software update is performed, the construction of the system program stored in the image processing apparatus 100 is not uniquely determined. To cope with this, the software construction information is transmitted from the image processing apparatus 100 to the update server 105, and identification of software to be updated and calculation of the update processing time period are performed on the update server-side. The identified software to be updated and the calculated update processing time period are transmitted from the update server 105 to the image processing apparatus 100 as update information, and then the difference package group 503 is transmitted to the image processing apparatus 100. The downloaded difference package group 503 is decompressed into the work area as update files.

In the update of software, only compressed file containing a file to be updated is decompressed from the divided compressed files 501. A plurality of compressed files to be decompressed are defined as a decompressed file group 502, and the update files are applied to these. Thereafter, the updated files are recompressed, and are stored in the software storage area 301. This makes it possible to reduce the decompression and compression time and reduce the work area used for the update.

Next, a description will be given of a software update method including a method of identifying compressed files of data (software) to which the present corresponding data is to be updated.

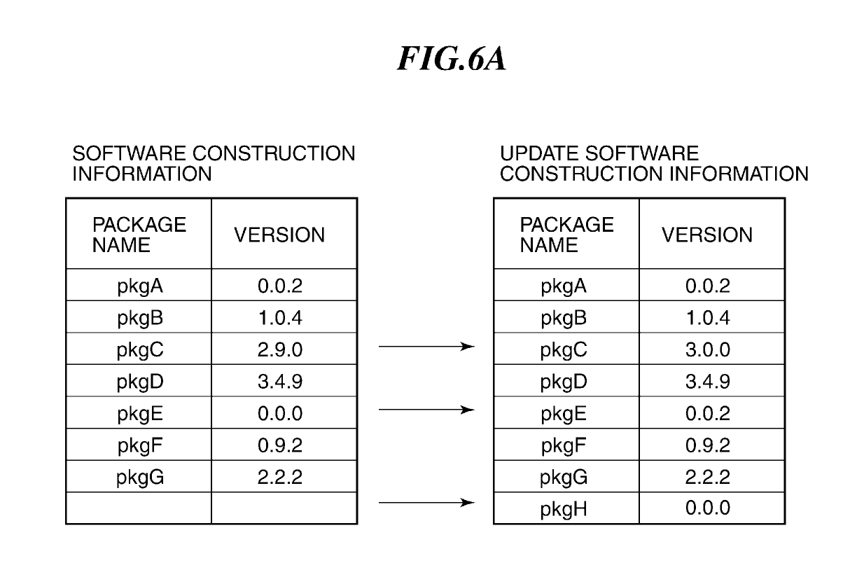

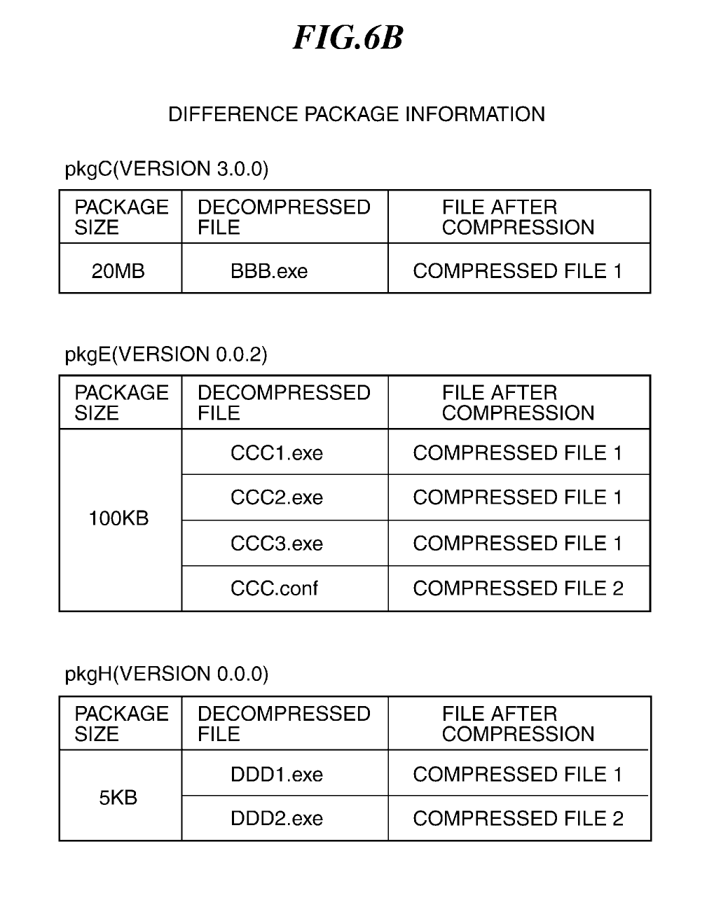

FIG. 6A illustrates an example of software construction information and update software information for identifying differences of the software.

The software construction information is held and managed by the software information management section 304 within the image processing apparatus 100. The software construction information indicates the construction of packages which the device holds as the software. For example, as shown in FIG. 6A, the software construction information is formed by respective names of a plurality of packages and respective versions of the packages.

The update software information management section 310 holds and manages the update software construction information in the same form as the above-mentioned software construction information, and identifies difference packages by comparing the update software construction information with the software construction information transmitted from the device. In FIG. 6A, it is possible to identify a package pkgC and a package pkgE as packages to be updated, and a package pkgH as a new package to be applied.

FIG. 6B illustrates an example of difference package information indicative of contents of the difference packages.

The difference package information is held and managed by the update software information management section 310 within the update server 105. The difference package information includes a package name, a version, a package size, respective names of decompressed files, and respective names of compressed applied files, of each difference package. In the illustrated example, the difference package information on the package pkgC, the package pkgE, and the package pkgH is described. The package sizes are acquired from all of these contents of the difference package information, and an OR (logical sum) of the compressed files to be updated is taken, whereby it is possible to calculate a total amount of data to be downloaded for the software update, and identify the compressed files required to be decompressed when applying the files.

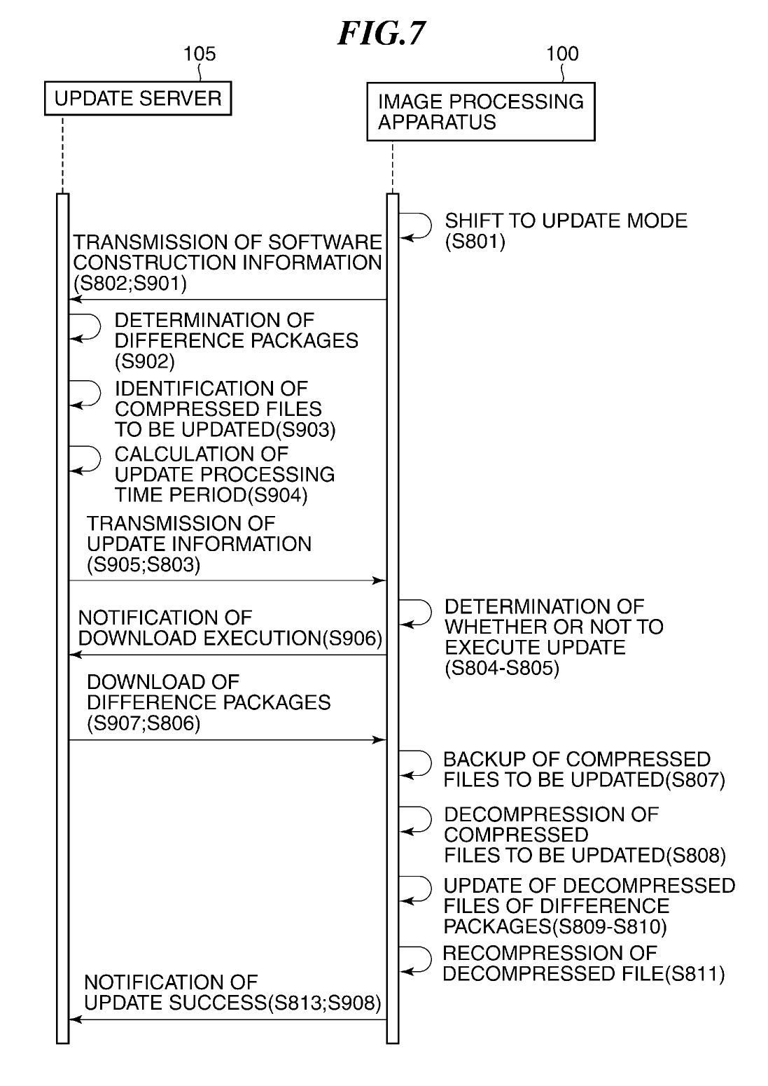

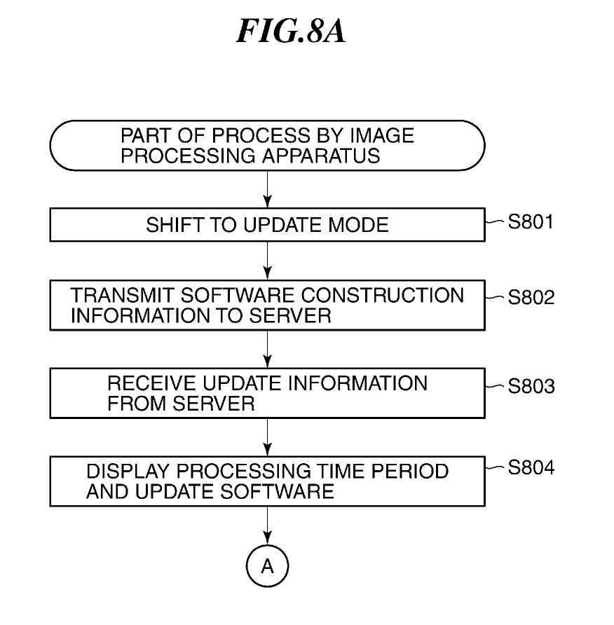

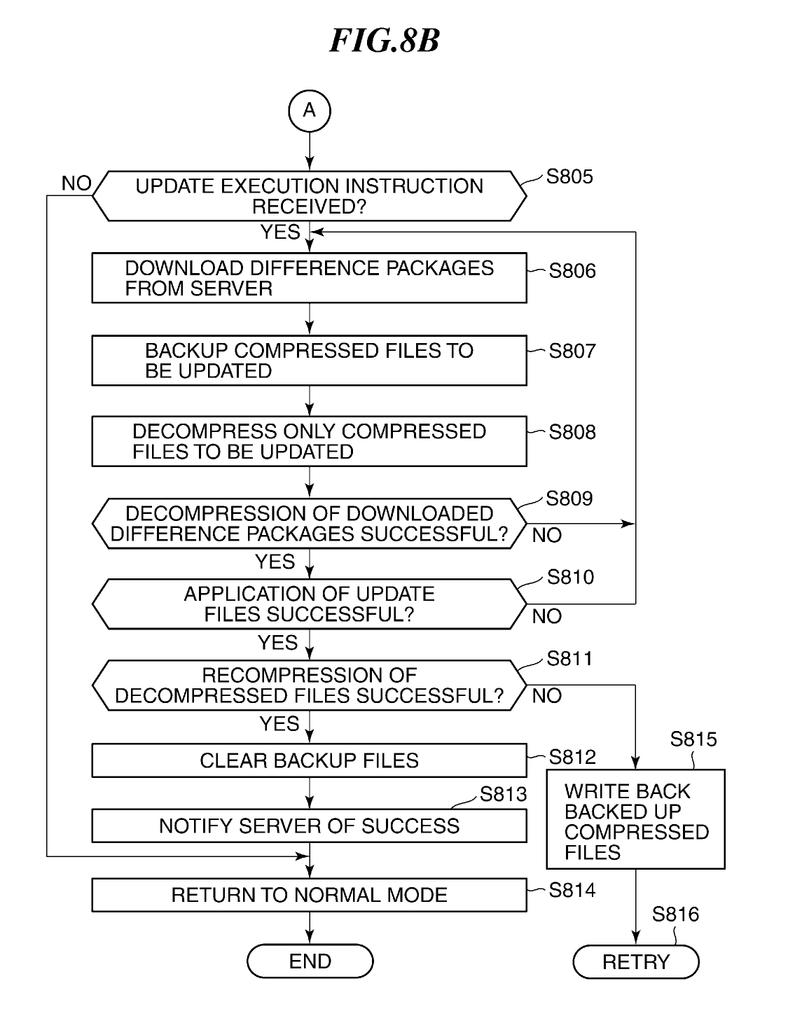

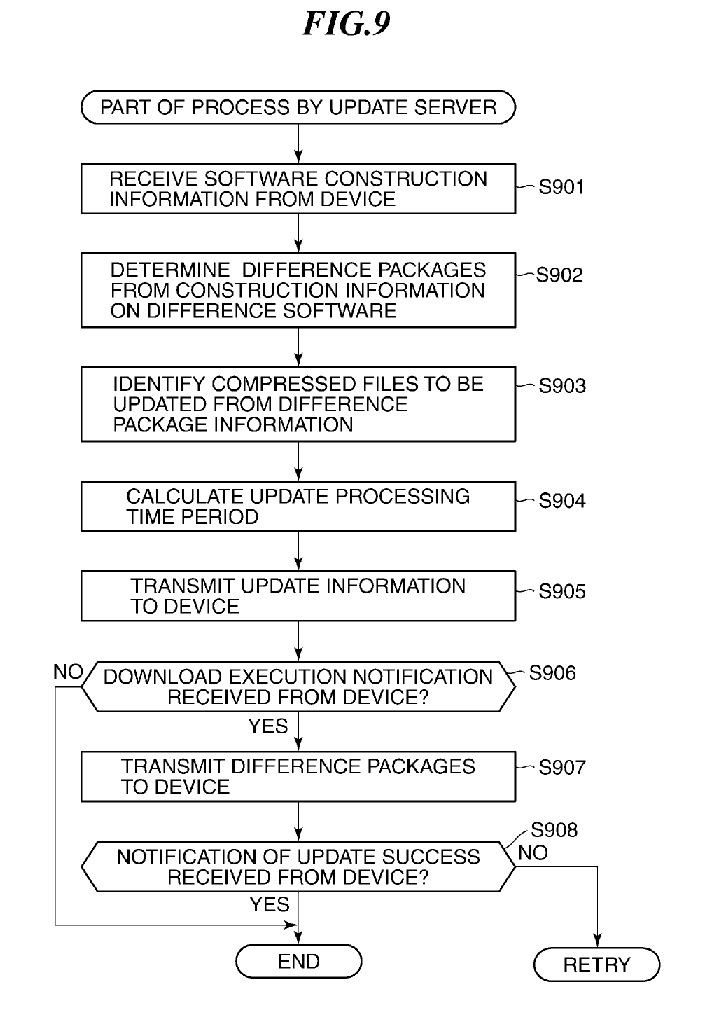

FIG. 7 is a sequence diagram showing a flow of a software update process performed between the image processing apparatus 100 and the update server 105. FIGS. 8A and 8B are a flowchart of a part of the software update process shown in FIG. 7, which is executed by the image processing apparatus. FIG. 9 is a flowchart of a part of the software update process shown in FIG. 7, which is executed in the update server 105. Note that the processing operations shown in FIG. 7 are denoted by the corresponding steps in the respective parts of the software update process executed by the image processing apparatus 100 and the update server 105 in FIGS. 8A, 8B, and 9, described hereinafter.

When an update instruction is provided from the user via the console section 102, the controller unit 101 shifts to an update mode after waiting for termination of normal processing, such as copy, print, or FAX transmission (step S801). Next, the communication processor 303 transmits the software construction information shown in FIG. 6A to the update server 105 (step S802). At this time, the communication processor 303 functions as a software construction information transmission unit. Thereafter, in the update server 105, the part of the process shown in FIG. 9, described hereinafter, is executed.

Next, the communication processor 303 receives update information including the download size and information on the identified compressed files to be updated from the update server 105 (step S803). At this time, the communication processor 303 functions as an update information reception unit.

Then, the software information management section 304 displays the update processing time period and the name of software to be updated on the console section 102 based on the update information received from the update server 105, and waits for selection by the user (step S804).

Next, the software information management section 304 determines whether or not an update execution instruction is given from the user via the console section 102 (step S805). If an update execution instruction is not given, and the operation is canceled, the process proceeds to a step S814, wherein the controller unit 101 returns to the normal mode, followed by terminating the present process. On the other hand, if an update execution instruction is given from the user, the communication processor 303 downloads the difference packages of the software to be updated from the update server 105 (step S806).

Next, before proceeding to updating of the software, the software backup processor 307 backs up the compressed files to be updated (step S807). Since the compressed files to be backed up at this time are only files to be updated, it is possible to reduce time required for the backup processing. Then, the compressed file decompression/compression processor 305 decompresses only the compressed files to be updated, and prepares for updating the files (step S808).

Next, the software update processor 306 decompresses the difference packages downloaded in the step S806 (step S809), and if the decompression is successful, the software update processor 306 further applies a group of the decompressed update files to the decompressed file group 502 (step S810). In the steps S809 and S810, if an error occurs due to some cause, such as a power interruption, the process returns to the step S806, wherein retry processing is performed.

If the application of the update files is successful (YES to the step S810), the software update processor 306 recompresses the decompressed file group to which the group of the update files is applied, and stores the recompressed file group in the software storage area 301 (step S811). At this time, if an error due to e.g. a power interruption occurs, the software backup processor 307 writes back the compressed files backed up in the step S807 (step S815).

When the step S811 is normally terminated, the software information management section 304 clears the backed up compressed files (step S812), and notifies the update server 105 of success of the update (step S813). Then, the controller unit 101 returns to the normal mode (step S814), followed by terminating the update process.

In FIG. 9, at the update server 105, the communication processor 309 receives the software construction information together with a notification of start of the update from the image processing apparatus 100 (step S901). At this time, the communication processor 309 functions as a software construction information reception unit.

Next, the difference software-determining section 311 compares the software construction information on the device with the update software construction information to thereby determine the difference packages (step S902).

Next, the to-be-updated compressed file-identifying section 312 identifies compressed files to be updated based on the difference package information on the difference packages, determined in the step S902 (step S903). In this step, the total size of the difference packages can be determined and the files to be decompressed can be identified at the same time, as described hereinbefore with reference to FIG. 6B.

Next, in a step S904, the software update time-calculating section 313 calculates a time period required to transfer the update files and a time period required to decompress the update files based on the total size of the difference packages, and calculates a time period required to apply the update files, based on information on the files to be decompressed. Further, the software update time-calculating section 313 calculates a time period required to decompress/recompress the compressed files based on the information on the compressed files to be updated. Then, by summing these time periods, the software update time-calculating section 313 calculates the update processing time period (step S904).

Next, the communication processor 309 transmits the difference packages determined in the step S902 and the update processing time period calculated in the step S904 to the image processing apparatus 100 as the update information (step S905). At this time, the communication processor 309 functions as an update information transmission unit.

If the communication processor 309 receives a download execution notification from the device (YES to a step S906), the communication processor 309 transmits the difference packages to the image processing apparatus 100 (step S907). On the other hand, if the communication processor 309 does not receive a download execution notification, the present process is terminated.

Next, if the update software information management section 310 receives an update success notification from the image processing apparatus 100 (YES to a step S908), the present process is terminated, whereas if the update software information management section 310 does not receive an update success notification, the retry processing is performed.

According to the above-described embodiment, it is possible to localize portions of software to be updated before downloading the update data, to thereby reduce the time required to update the software. Further, it is possible to identify the portions to be updated and calculate an update processing time period before downloading the data by exchanging data having a small size, such as the software construction information and the package information. This makes it possible to predict a processing time period required to complete the update of the software.

Next, a second embodiment of the present invention will be described. The second embodiment is the same as the first embodiment in the configuration shown in FIGS. 1 and 2, so that component elements corresponding to those in the first embodiment are denoted by identical reference numerals, and description thereof is omitted. Hereinafter, a description will be given of only different points.

FIG. 3 is a schematic block diagram of modules of the image processing apparatus for performing update processing therein and modules of the update server 105 for update processing.

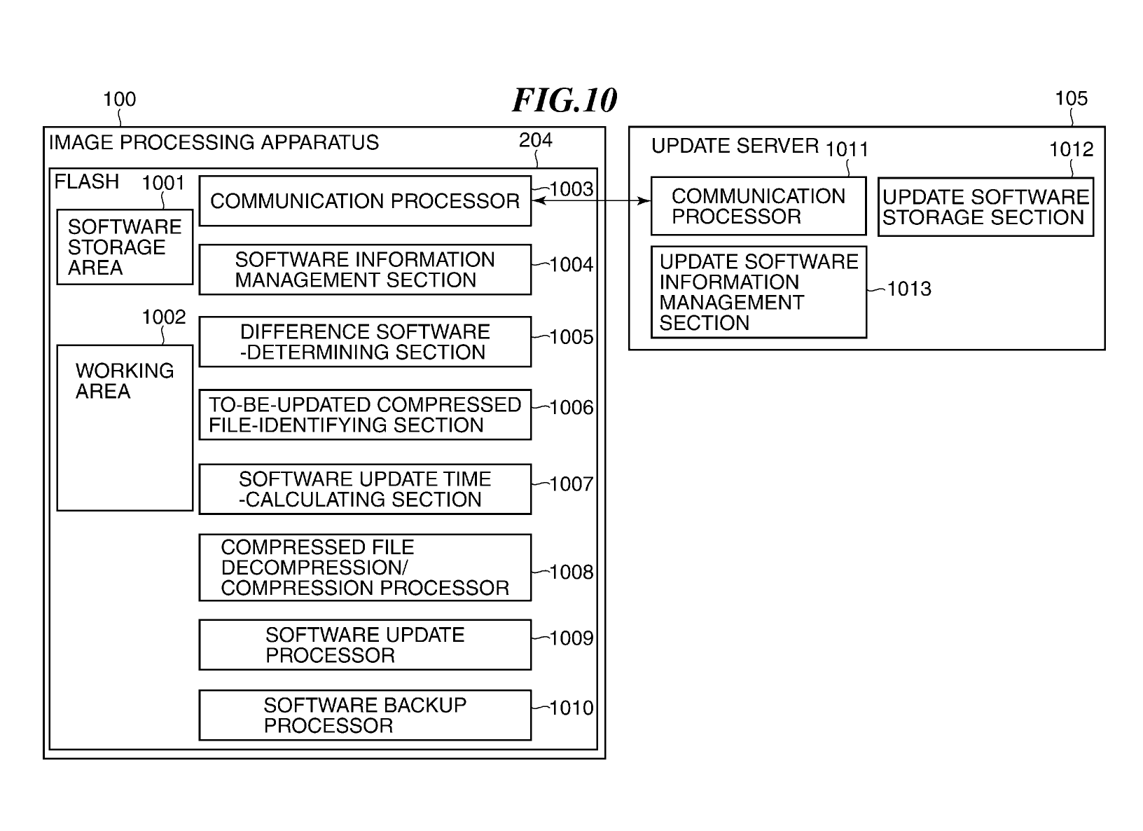

The update processing within the image processing apparatus is executed by the controller unit 101 and the modules, described hereinafter. These modules are stored in the flash memory 204 as shown in FIG. 10, and provide functions, described hereinafter, according to instructions and commands from the controller unit 101.

In FIG. 10, a software storage area 1001 is an area which stores the system program for realizing the operations of the image processing apparatus 100. The software to be updated is the program stored in this area. A working area 1002 is an area for temporarily storing print data and image files in the normal operation, and in the update operation, operations, such as those of a job, are stopped, and using this area, compressed files of the program are decompressed, and update files are applied thereto.

Communication processors 1003 and 1011 are modules for inputting and outputting update software, software construction information, etc. between the image processing apparatus 100 and the update server 105. Note that these modules may be implemented by hardware.

In the image processing apparatus 100, a software information management section 1004 is a management module for managing software construction information, such as version information on the system program stored in the software storage area 301 and construction information on a compressed file. A difference software-determining section 1005 is a module which compares the software construction information managed by the software information management section 1004 with the update software construction information received from the update server 105 to thereby determine difference software. A to-be-updated compressed file-identifying section 1006 is a module which identifies compressed files to be updated based on the difference software information determined by the difference software-determining section 1005. A software update time-calculating section 1007 calculates a processing time required for the software update by taking into account difference software information and information on compressed files to be updated, and device information on the image processing apparatus to be updated. The update processing time period is thus determined by taking into account all of a time period required to transfer update files, a time period required to decompress compressed files, a time period required to decompress the downloaded files, a time period required to apply the update files, and a time period required to recompress updated decompressed files.

A compressed file decompression/compression processor 1008 is a module for decompressing and recompressing software compressed and stored in the software storage area 1001. A software update processor 1009 is a module which performs processing for decompressing update software received from the update server 105, and applying updated files to a program decompressed by the compressed file decompression/compression processor 305.

A software backup processor 1010 is a module which backs up a compressed file to be updated before decompressing software by the compressed file decompression/compression processor 1008, for recovery processing in a case where an error occurs during the update of software.

In the update server 105, an update software storage section 1012 is a storage area (or a storage device) for collectively storing data of a plurality of pieces of software managed by the update server 105. An update software information management section 1013 is a management module which holds the software construction information, such as version information on the system program for update processing, stored in the update software storage area 1012, and construction information on a compressed file.

The flow of the software difference updating in the second embodiment is the same as that shown in FIG. 5, and hence description thereof is omitted. Further, the software construction information and the package information in the second embodiment is the same as that shown in FIG. 6, and hence description thereof is omitted.

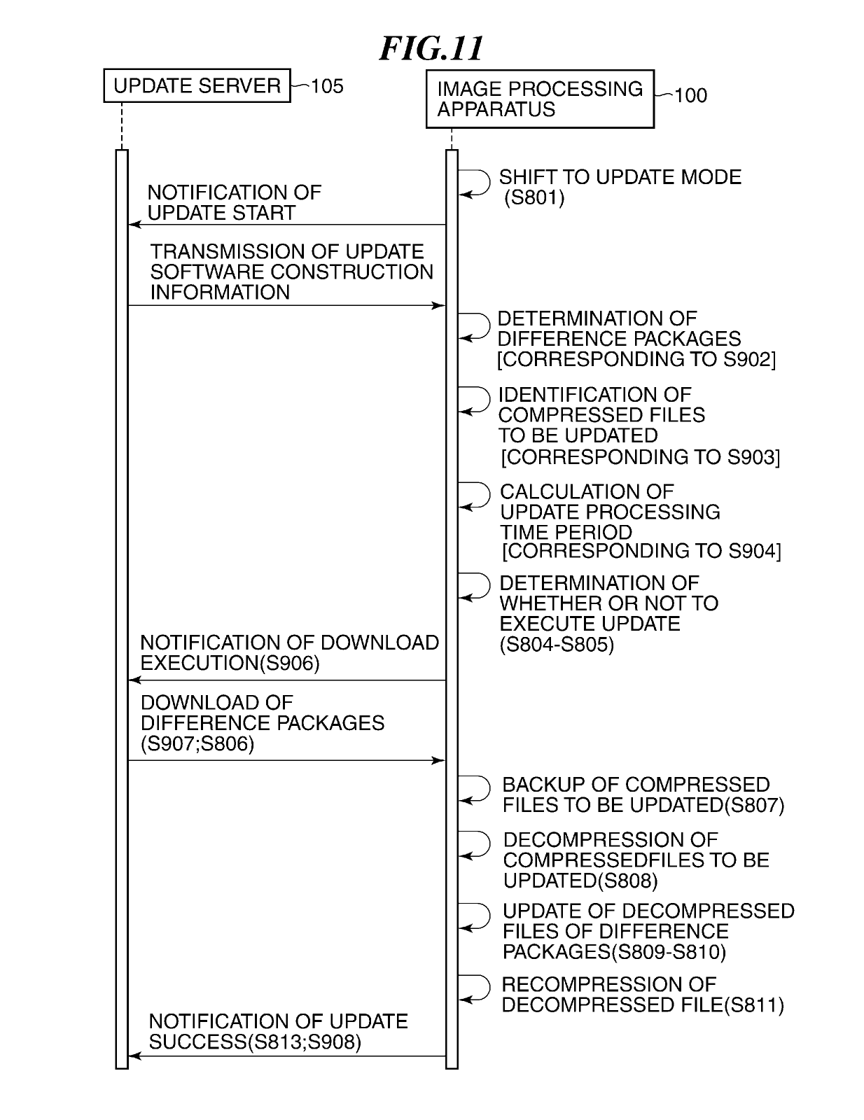

FIG. 11 is a sequence diagram showing a flow of the software update process between the image processing apparatus 100 and the update server 105 in the second embodiment. Note that the processing operations shown in FIG. 11 are denoted by step numbers corresponding to the steps in the software update processes executed in the image processing apparatus 100 and the update server 105, described hereinabove with reference to FIGS. 8A, 8B, and 9.

In the present embodiment, it is assumed that the determination of the difference packages (step S902), identification of the compressed file to be updated (step S903), and calculation of the update processing time period (step S903) performed on the server side in the above-described first embodiment are all performed within the image processing apparatus 100. Description of the same process as that in the first embodiment is omitted.

As shown in FIG. 11, in the update server 105, upon receipt of an update start notification from the image processing apparatus 100, the update software construction information shown in FIG. 6A is transmitted to the image processing apparatus 100. At this time, the communication processor 1003 functions as an update software construction information reception unit.

Then, the difference software-determining section 1005 executes a process corresponding to the step S902 in the first embodiment on the image processing apparatus side. The to-be-updated compressed file-identifying section 1006 performs a process corresponding to the step S903 in the first embodiment on the image processing apparatus side. The software update time-calculating section 1007 performs a process corresponding to the step S904 in the first embodiment on the image processing apparatus side.

In the software update process in the second embodiment, the determination of the difference packages, identification of the compressed files to be updated, and calculation of the update processing time period are performed by the image processing apparatus 100. The update server 105 is only required to transmit the update software construction information to the image processing apparatus 100 before transmitting the difference packages, and hence it is possible to reduce the load on the server side.

Although in the above-described embodiment, the description has been given of the image processing apparatus and the method of controlling the same, it is obvious that the control program for realizing the control method, and the information processing system including the above-described image processing apparatus are also included in the category of an embodiment to which the present invention can be applied. Further, the present invention is not limitedly applied to the image processing apparatus, but may be also applied to a an information processing apparatus, such as a PC.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2010-190722 filed Aug. 27, 2010, which is hereby incorporated by reference herein in its entirety.

What is claimed is:

1. An image processing apparatus that receives at least one update file from a server on a network, and updates software based on the at least one update file, comprising:
a storage unit configured to store the software in a state divided into a plurality of compressed files;
a decompression unit configured to decompress at least one compressed file to be updated out of the plurality of compressed files stored in said storage unit;
an update unit configured to update the at least one compressed file decompressed by said decompression unit, based on the at least one update file received from the server; and
a compression unit configured to recompress and store the at least one compressed file which is decompressed and updated, in said storage unit.

2. The image processing apparatus according to claim 1,
wherein the server comprises:
a software construction information reception unit configured to receive software construction information including names and versions of respective packages forming the software from the image processing apparatus;
a difference software-determining unit configured to determine at least one difference package by comparing the received software construction information with update software information for identifying differences from updated software; and
an update information transmission unit configured to transmit update information including information on the at least one update file as the at least one difference package to the image processing apparatus.

3. The image processing apparatus according to claim 2,
wherein the server further comprises:
a compressed file identification unit configured to identify the at least one compressed file to be updated from difference package information on the at least one difference package determined by said difference software-determining unit; and
an update time calculation unit configured to calculate a processing time period required to update the software from the difference package information and information on the at least one identified compressed file, and
wherein said update information transmission unit transmits the update information which includes the difference package information and the update processing time period to the image processing apparatus.

4. The image processing apparatus according to claim 2, further comprising:
a software construction information transmission unit configured to transmit the software construction information to the server; and
an update information reception unit configured to receive the update information, and
wherein said decompression unit identifies and decompress the at least one compressed file to be updated based on the update information.

5. The image processing apparatus according to claim 1, further comprising:
an update software construction information reception unit configured to receive update software information for identifying differences from updated software, from the server; and
a difference software-determining unit configured to determine the at least one difference package by comparing software construction information including names and versions of respective packages forming the software with the received update software information, and
wherein said decompression unit identifies and decompresses the at least one compressed file to be updated based on update information including information on the at least one difference package.

6. The image processing apparatus according to claim 5, further comprising:
a compressed file identification unit configured to identify the at least one compressed file to be updated from difference package information on the at least one difference package determined by said difference software-determining unit; and
an update time calculation unit configured to calculate a processing time required to update the software from the difference package information and information on the identified at least one compressed file, and
wherein said decompression unit identifies and decompresses the at least one compressed file to be updated based on the update information which includes the difference package information and the update processing time period.

7. The image processing apparatus according to claim 2, wherein the difference package information includes at least a package name, a version, and a package size of each difference package, names of decompressed files contained in the difference package, and names of compressed updated files.

8. A method of controlling an image processing apparatus that receives at least one update file from a server on a network, and updates software based on the at least one update file, comprising:
storing the software in a state divided into a plurality of compressed files;
decompressing at least one compressed file to be updated out of the plurality of compressed files stored in the storage unit;
updating the decompressed at least one file, based on the at least one update file received from the server; and
recompressing and storing the at least one compressed file which is decompressed and updated, in the storage unit.

9. An information processing system including an image processing apparatus that receives at least one update file from a server on a network, and updates software based on the at least one update file,
the image processing apparatus comprising:
a storage unit configured to store the software in a state divided into a plurality of compressed files;
a decompression unit configured to decompress at least one compressed file to be updated out of the plurality of compressed files stored in said storage unit;
an update unit configured to update the at least one compressed file decompressed by said decompression unit, based on the at least one update file received from the server; and
a compression unit configured to recompress and store the at least one compressed file which is decompressed and updated, in said storage unit,
the server comprising:
a software construction information reception unit configured to receive software construction information including names and versions of respective packages forming the software from the image processing apparatus;
a difference software-determining unit configured to determine at least one difference package by comparing the received software construction information with update software information for identifying differences from updated software;
a compressed file identification unit configured to identify the at least one compressed file to be updated from difference package information on the at least one difference package determined by said difference software-determining unit;
an update time calculation unit configured to calculate a processing time period required to update the software from the difference package information and information on the at least one identified compressed file; and
an update information transmission unit configured to transmit update information including the difference package information and the update processing time period to the image processing apparatus,
wherein said decompression unit identifies and decompresses the at least one compressed file to be updated based on the update information received from the server.

10. An information processing system including an image processing apparatus that receives at least one update file from a server on a network, and updates software based on the at least one update file,
the image processing apparatus comprising:
a storage unit configured to store the software in a state divided into a plurality of compressed files;
a decompression unit configured to decompress at least one compressed file to be updated out of the plurality of compressed files stored in said storage unit;
an update unit configured to update the at least one compressed file decompressed by said decompression unit, based on the at least one update file received from the server;
a compression unit configured to recompress and store the at least one compressed file which is decompressed and updated, in said storage unit;
an update software construction information reception unit configured to receive update software information for identifying differences from updated software, from the server;
a difference software-determining unit configured to determine at least one difference package by comparing software construction information including names and versions of respective packages forming the software with the received update software information;
a compressed file identification unit configured to identify the at least one compressed file to be updated from difference package information on the at least one difference package determined by said difference software-determining unit; and
an update time calculation unit configured to calculate a processing time required to update the software from the difference package information and information on the identified at least one compressed file,
wherein said decompression unit identifies and decompresses the at least one compressed file to be updated based on update information including the difference package information and the update processing time period.

11. A non-transitory computer-readable storage medium storing a computer-executable program for causing a computer of an image processing apparatus to execute a method of controlling the image processing apparatus that receives at least one update file from a server on a network, and updates software based on the at least one update file,
wherein the method comprises:
storing the software in a state divided into a plurality of compressed files;
decompressing at least one compressed file to be updated out of the plurality of compressed files stored in the storage unit;
updating the decompressed at least one file, based on the at least one update file received from the server; and
recompressing and storing the at least one compressed file which are decompressed and updated, in the storage unit.
